(19) United States
(12) Patent Application Publication
(10) Pub. No.: US 2016/0240302 A1
(43) Pub. Date: Aug. 18, 2016

(54) SUBSTRATE STRUCTURE

(71) Applicant: Siliconware Precision Industries Co., Ltd., Taichung (TW)

(72) Inventors: Ming-Fan Tsai, Taichung (TW); Ho-Chuan Lin, Taichung (TW); Ying-Wei Lu, Taichung (TW)

(21) Appl. No.: 14/981,184

(22) Filed: Dec. 28, 2015

(30) Foreign Application Priority Data
Feb. 17, 2015 (TW) 104105544

(51) Int. Cl. H01F 27/28; H01F 1/04

(52) U.S. Cl. CPC H01F 27/2804; H01F 1/04

(57) ABSTRACT

A substrate structure is provided, which includes: a first dielectric layer having a magnetic material; a circuit layer having an inductor circuit and a plurality of conductive traces; and a second dielectric layer bonded to the first dielectric layer and encapsulating the circuit layer. As such, the inductance value of the inductor circuit is increased due to the magnetic material of the first dielectric layer, thereby eliminating the need to increase the number of coils of the inductor circuit.

### BACKGROUND OF THE INVENTION

1. Field of the Invention

The present invention relates to substrates used for semiconductor packaging processes, and more particularly, to a substrate structure having an inductor.

2. Description of Related Art

As electronic products are developed toward the trend of miniaturization, chip size is becoming smaller. Accordingly, passive elements such as inductors, capacitors and resistors that are implemented through packaging technologies are generally disposed in packaging substrates instead of chips. Since inductors occupy a large area, they tend to be implemented through packaging technologies.

In a conventional chip scale package (CSP), a circuit fan-in or fan-out design is achieved through a plurality of redistribution layers (RDLs). Therein, inductors are made of wound wires of the RDLs.

FIG. 1 is a schematic partial cross-sectional view of a conventional packaging substrate 1.

Referring to FIG. 1, the packaging substrate 1 has a circuit structure 10 including a plurality of dielectric layers 11, 12 and a plurality of redistribution layers 13. One of the redistribution layers 13 has a plurality of conductive traces 130 and an inductor coil 131.

In the case the number of the redistribution layers 13 is not changed, the number of coils of the inductor 131 needs to be increased to achieve a larger inductance value.

However, increasing the number of coils of the inductor 131 means a larger area of the dielectric layer 11 will be occupied by the inductor 131. For example, FIG. 1′ shows two coils of the inductor 131′. As such, less space is available in the redistribution layer 13 for routing the conductive traces 130. That is, the area of the dielectric layer 11 occupied by the conductive traces 130 is reduced.

Therefore, how to overcome the above-described drawbacks has become critical.

### SUMMARY OF THE INVENTION

In view of the above-described drawbacks, the present invention provides a substrate structure, which comprises: a first dielectric layer comprising a magnetic material; a circuit layer having at least an inductor circuit and a plurality of conductive traces; and a second dielectric layer bonded to the first dielectric layer and encapsulating the circuit layer.

In the above-described structure, the magnetic material can be Fe, Co or Ni.

In the above-described structure, the inductor circuit can have a spiral coil shape.

In an embodiment, the second dielectric layer has opposite first and second surfaces, the circuit layer is embedded in the second dielectric layer via the first surface thereof, and the first dielectric layer is bonded to the first surface of the second dielectric layer.

In an embodiment, the second dielectric layer has opposite first and second surfaces, the circuit layer is embedded in the second dielectric layer via the first surface thereof, and the first dielectric layer is bonded to the second surface of the second dielectric layer.

The above-described structure can further comprise a substrate body for allowing the first dielectric layer or the second dielectric layer to be formed thereon. The substrate body can be made of a conductor, semiconductor or insulator material.

The above-described structure can further comprise a wiring layer and a plurality of conductive vias embedded in the first dielectric layer, wherein the circuit layer is electrically connected to the wiring layer through the conductive vias.

The above-described structure can further comprise a wiring layer embedded in the first dielectric layer and a plurality of conductive vias embedded in the second dielectric layer, wherein the circuit layer is electrically connected to the wiring layer through the conductive vias.

According to the present invention, since the first dielectric layer comprises a magnetic material, the inductance value of the inductor circuit is increased. Therefore, the present invention eliminates the need to increase the number of coils of the inductor circuit so as not to adversely affect the space in the circuit layer for routing the conductive traces.

### BRIEF DESCRIPTION OF DRAWINGS

FIGS. 1 and 1′ are schematic partial cross-sectional views of a conventional packaging substrate;

FIG. 2 is a schematic partial cross-sectional view of a substrate structure of the present invention;

FIG. 2′ shows another embodiment of FIG. 2;

FIG. 3 is a schematic lower view of an inductor circuit of the substrate structure of the present invention; and

FIG. 4 is a schematic upper perspective view of the inductor circuit of FIG. 3.

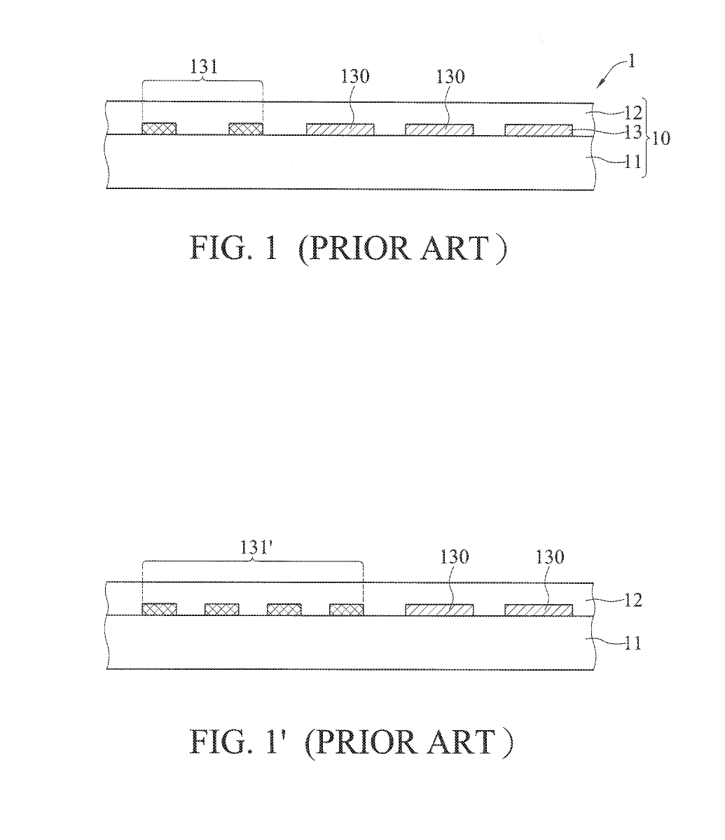

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are not intended to limit the present invention. Various modifications and variations can be made without departing from the spirit of the present invention. Further, terms such as “first”, “second”, “on”, “a” etc. are merely for illustrative purposes and should not be construed to limit the scope of the present invention.

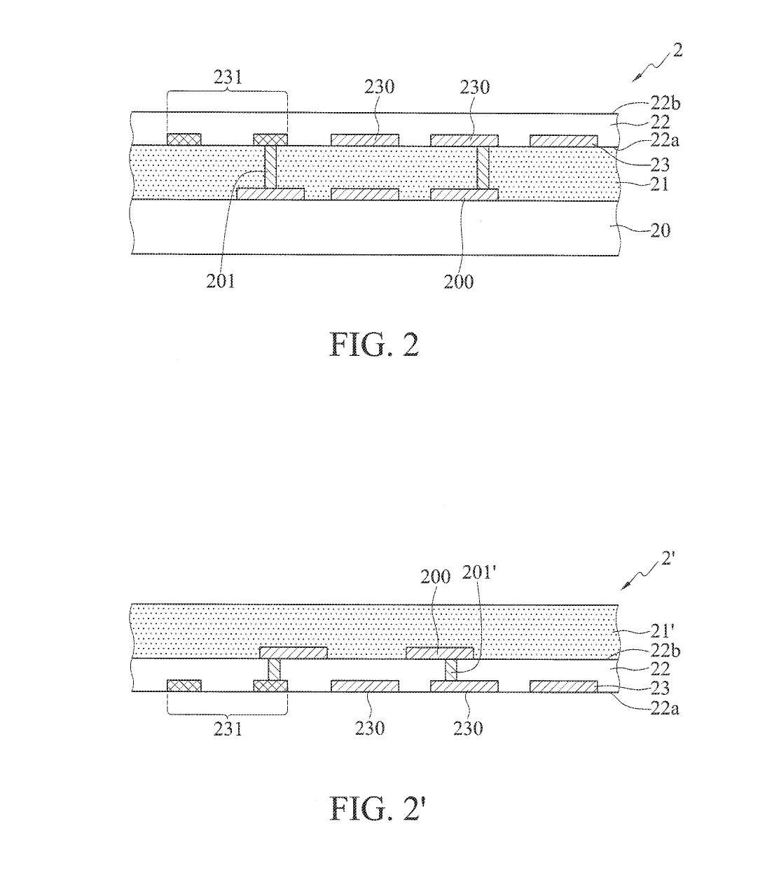

FIG. 2 is a schematic partial cross-sectional view of a substrate structure 2 of the present invention.

Referring to FIG. 2, the substrate structure 2 has: a substrate body 20, a first dielectric layer 21 formed on the substrate body 20, a circuit layer 23 formed on the first dielectric layer 23, and a second dielectric layer 22 formed on the first dielectric layer 21 and encapsulating the circuit layer 23.

The substrate body 20 is made of a conductor, semiconductor or insulator material. In the present embodiment, the substrate body 20 has a wiring layer 200 formed thereon. In another embodiment, referring to FIG. 2′, the substrate structure 2′ is of a coreless type and the substrate body 20 is dispensed with. Therefore, the substrate body 20 is optional.

The first dielectric layer 21 is formed on the substrate body 20 and encapsulates the wiring layer 200. The first dielectric layer 21 includes a magnetic material, for example, Fe, Co or Ni. In the present embodiment, a plurality of conductive vias 201 are formed in the first dielectric layer 21 and electrically connected to the wiring layer 200.

The circuit layer 23 is formed on the first dielectric layer 21 and has an inductor circuit 231 and a plurality of conductive traces 230.

In the present embodiment, the circuit layer 23 is electrically connected to the conductive vias 201 so as to allow the inductor circuit 231 or the conductive traces 230 to be electrically connected to the wiring layer 200 through the conductive vias 201.

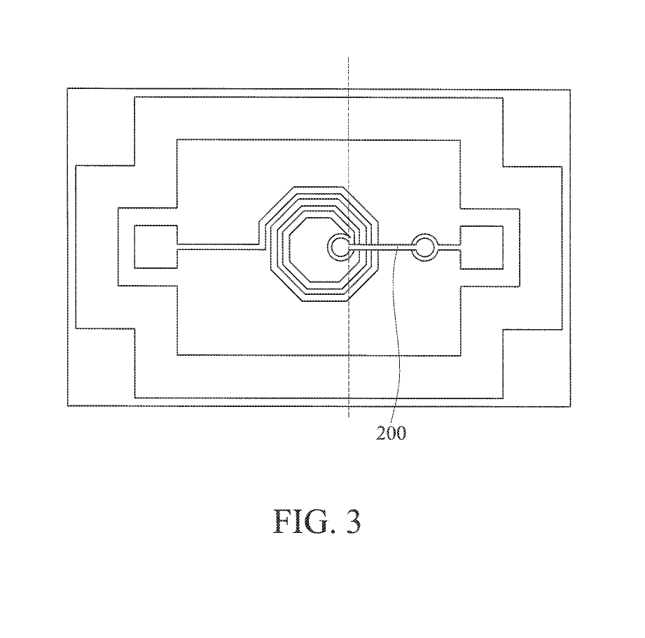

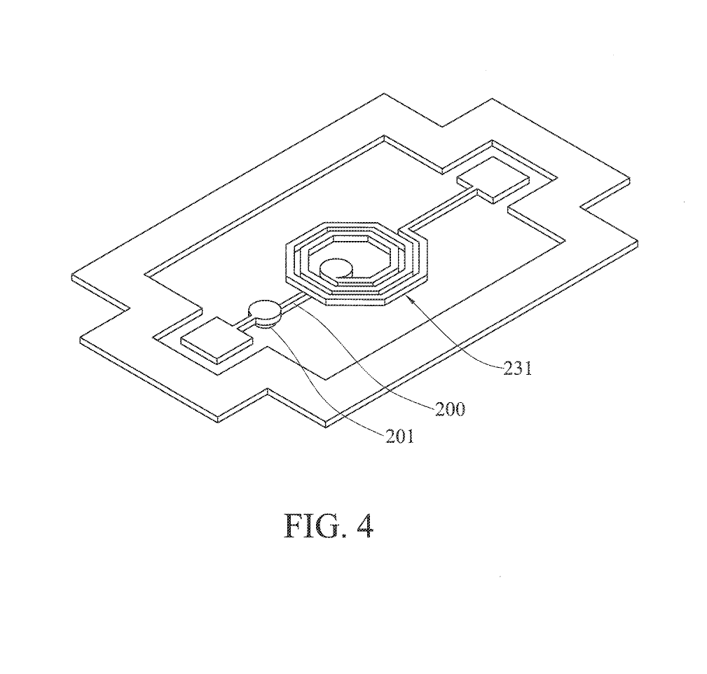

The number of coils of the inductor circuit 231 can be designed according to the practical need. FIGS. 3 and 4 are schematic lower view and upper perspective view of the inductor circuit 231. Referring to FIGS. 3 and 4, the inductor circuit 231 has a spiral coil shape and the number of coils is three.

The second dielectric layer 22 is formed on the first dielectric layer 21 and encapsulating the circuit layer 23.

In the present embodiment, the second dielectric layer 22 has a first surface 22a and a second surface 22b opposite to the first surface 22a. The first dielectric layer 21 is boned to the first surface 22a of the second dielectric layer 22, and the circuit layer 23 is embedded in the second dielectric layer 22 via the first surface 22a thereof.

In another embodiment, referring to FIG. 2′, the first dielectric layer 21′ is bonded to the second surface 22b of the second dielectric layer 22, the circuit layer 23 is embedded in the second dielectric layer 22 via the first surface 22a, and the conductive vias 201′ are embedded in the second dielectric layer 22 for electrically connecting the circuit layer 23 and the wiring layer 200.

According to the present invention, since the first dielectric layer 21, 21′ includes a magnetic material, the inductance value of the inductor circuit 231 is increased. That is, in the case the number of coils is the same, the inductance value of the inductor circuit 231 of the present invention is greater than that of the conventional inductor 131. Therefore, the present invention eliminates the need to increase the number of coils of the inductor circuit 231 so as not to adversely affect the space in the circuit layer 23 for routing the conductive traces 230.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A substrate structure, comprising:
a first dielectric layer comprising a magnetic material;
a circuit layer having at least an inductor circuit and a plurality of conductive traces; and
a second dielectric layer bonded to the first dielectric layer and encapsulating the circuit layer.

2. The structure of claim 1, wherein the magnetic material is Fe, Co or Ni.

3. The structure of claim 1, wherein the inductor circuit has a spiral coil shape.

4. The structure of claim 1, wherein the second dielectric layer has opposite first and second surfaces, the circuit layer being embedded in the second dielectric layer via the first surface thereof and the first dielectric layer being bonded to the first surface of the second dielectric layer.

5. The structure of claim 1, wherein the second dielectric layer has opposite first and second surfaces, the circuit layer being embedded in the second dielectric layer via the first surface thereof and the first dielectric layer being bonded to the second surface of the second dielectric layer.

6. The structure of claim 1, further comprising a substrate body for allowing the first dielectric layer or the second dielectric layer to be formed thereon.

7. The structure of claim 6, wherein the substrate body is made of a conductor, semiconductor or insulator material.

8. The structure of claim 1, further comprising a wiring layer and a plurality of conductive vias embedded in the first dielectric layer, wherein the circuit layer is electrically connected to the wiring layer through the conductive vias.

9. The structure of claim 1, further comprising a wiring layer embedded in the first dielectric layer and a plurality of conductive vias embedded in the second dielectric layer, wherein the circuit layer is electrically connected to the wiring layer through the conductive vias.
